(19) United States
(12) Patent Application Publication
(10) Pub. No.: US 2011/0156468 A1
(43) Pub. Date: Jun. 30, 2011

(54) Apparatus for the suspension of a person

(76) Inventor: Roy Morgan Holland, Santa Maria, CA (US)

(21) Appl. No.: 12/655,445

(22) Filed: Dec. 29, 2009

(51) Int. Cl. A47C 31/00; B60R 22/00

(52) U.S. Cl. 297/465

(57) ABSTRACT

A System and Apparatus for Suspending a Person includes a suspension vest, and a mating chair appendage. The suspension vest is coupled with the mating chair appendage. In some preferred embodiments, this coupling is made through cooperating loops and hooks material found on the suspension vest, and a mating chair appendage.

### FIELD OF THE INVENTION

The present invention is a device used to suspend a person from a chair or a seat.

### BACKGROUND OF THE INVENTION

For many reasons, some people have found that being suspended from a seat or a chair is preferable, beneficial or has practical advantages to sitting on the seat of a chair. These reasons, benefits, and advantages may differ amongst many different people. Unfortunately, in the present marketplace, there does not exist a system or apparatus designed to enable a person to be suspended in a seated position as opposed to resting one's body weight upon a chair or a seat's lower support member. Therefore, what is clearly needed in the marketplace is a system and apparatus used to suspend a person in a chair or seat.

### SUMMARY OF THE INVENTION

It is an object of the present invention to provide an apparatus which can enable a person to remain in a seated position by suspending some or all of their body weight against the upright back rest (hereafter upright portion of a chair or seat) of the seat or chair. This suspension is achieved by a person wearing a vest which mates with a chair appendage. This coupling between the vest and the chair appendage may be accomplished through simple loops and hooks material which are affixed to both objects.

It is an object of the present invention to provide a system and apparatus which is immediately adaptable to many sizes of people. Moreover, the present invention is also scalable in size and configuration to be adaptable for an assortment of office chairs, as well as car seats.

### BRIEF DESCRIPTION OF THE DRAWING FIGURES

FIG. 1 is a planar view of a preferred embodiment of the present invention.

FIG. 1a is a planar view of a preferred embodiment of the present invention.

FIG. 1b is a planar view of a preferred embodiment of the present invention.

FIG. 1c is a planar view of a preferred embodiment of the present invention.

FIG. 1d is a planar view of a preferred embodiment of the present invention.

FIG. 2 is a frontal view of a preferred embodiment of the present invention.

FIG. 3 is a frontal view of a preferred embodiment of the present invention.

FIG. 4 is a frontal view of a preferred embodiment of the present invention.

FIG. 5 is a planar view of a preferred embodiment of the present invention.

FIG. 5a is a planar view of a preferred embodiment of the present invention.

FIG. 6 is a perspective view of a preferred embodiment of the present invention.

FIG. 6a is a perspective view of a preferred embodiment of the present invention.

FIG. 7 is a perspective view of a preferred embodiment of the present invention.

FIG. 8 is a perspective view of a preferred embodiment of the present invention.

FIG. 9 is a perspective view of a preferred embodiment of the present invention.

FIG. 10 is a side view of a preferred embodiment of the present invention.

FIG. 11 is a planar view of a preferred embodiment of the present invention.

FIG. 12 is a planar view of a preferred embodiment of the present invention.

### DESCRIPTION OF PREFERRED EMBODIMENTS

According to a preferred embodiment of the present invention, a unique system and apparatus is used to suspend a person in a seated position rather than resting one's body weight on top of the lower support member of a chair or seat. Mechanically, this is accomplished by affixing a person's torso to the upright portion of a chair thereby reducing the amount of force displaced from the bottom portion of a chair. It should be noted here that the present invention is adaptable for use with office chairs or other seats with an upright support and a lower support. The present invention is described in enabling detail below.

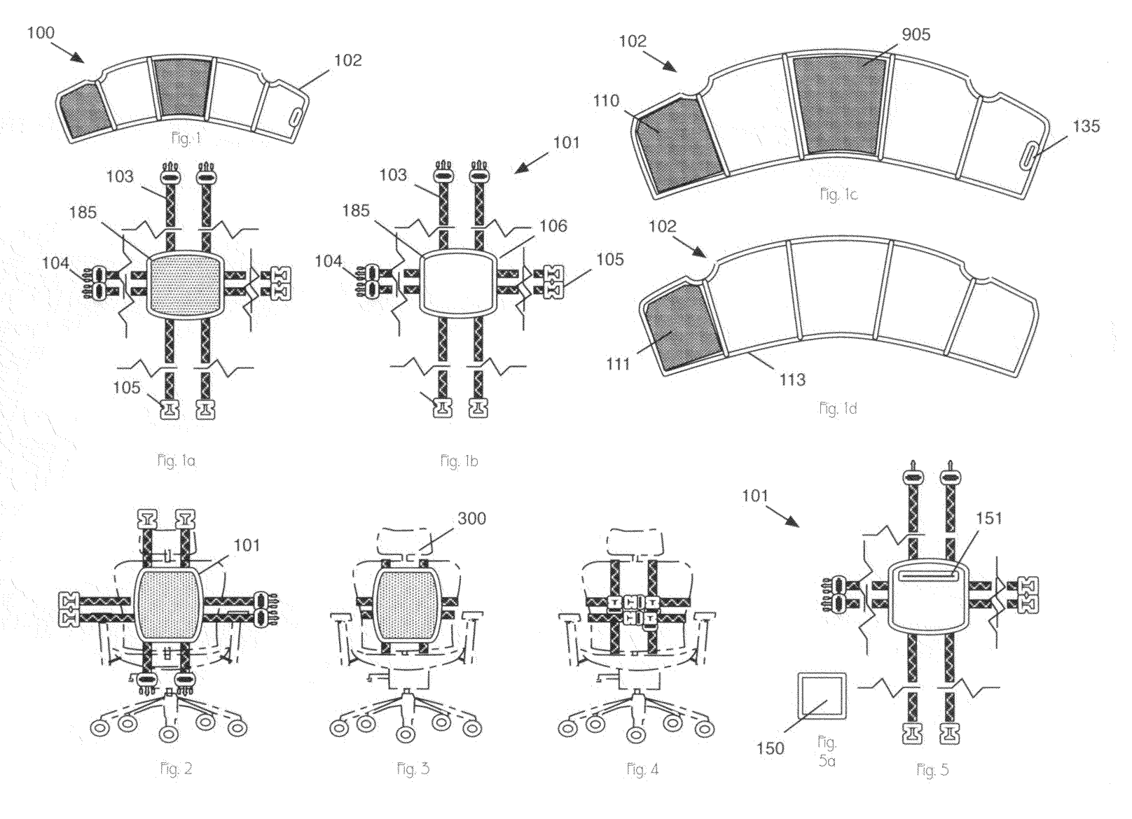

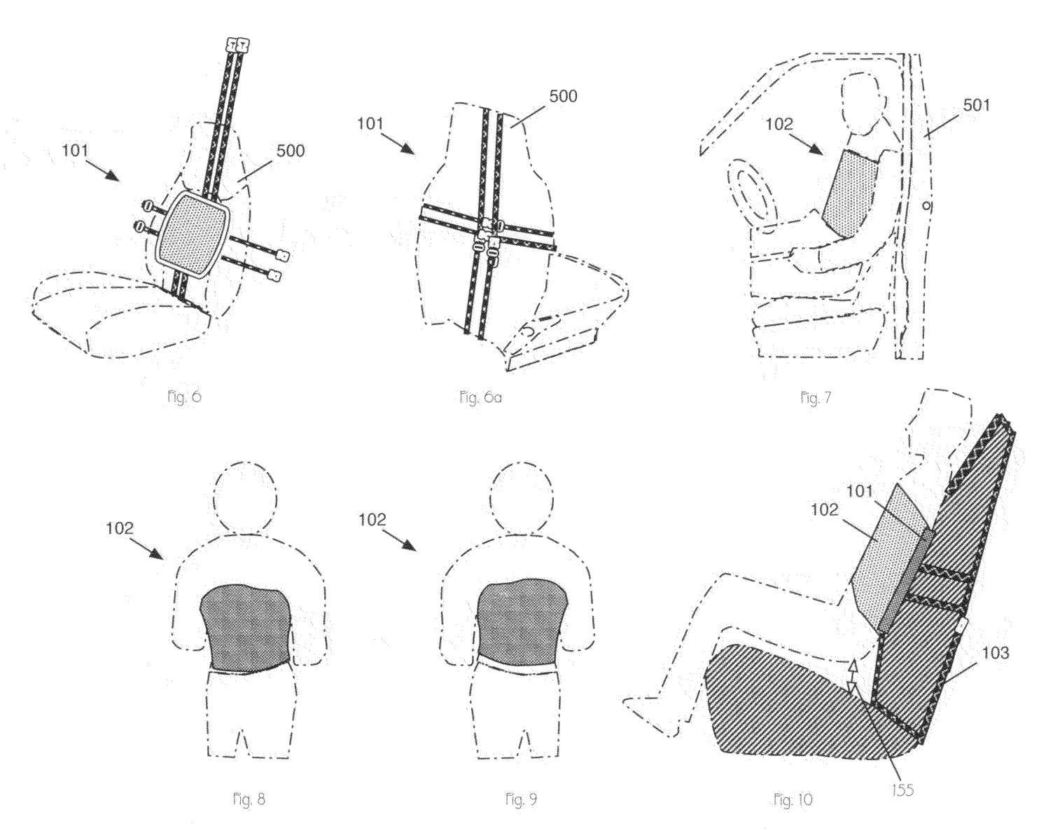

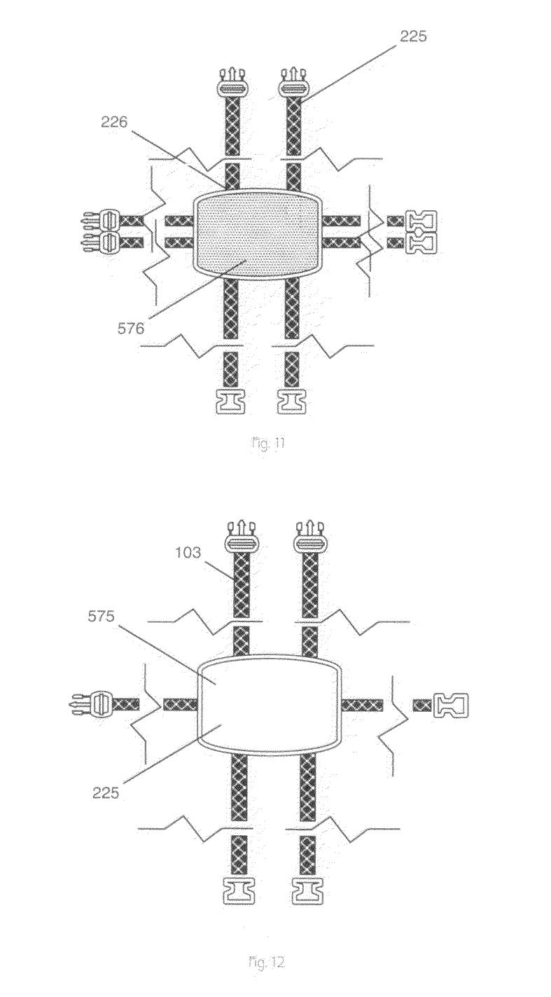

FIGS. 1a-1b illustrate a preferred embodiment of the present invention. A System and Apparatus for Suspending a Person 100 includes a suspension vest 102, and a mating chair appendage 101. FIG. 6c illustrates that the suspension vest 102 is coupled with the mating chair appendage 101. In some preferred embodiments, this coupling is made through cooperating loops and hooks material found on the suspension vest 102, and a mating chair appendage 101. Also, as illustrated in FIGS. 8-9, the suspension vest 102 is wrapped around the torso of a person.

FIG. 1a illustrates that the suspension vest 102 is a flexible, elongate, and planar member. The suspension vest 102 is comprised of a set of fitting loops and hooks regions 110, 111 and a suspension region of hooks or loops 905 as illustrated in FIG. 13. The set of fitting loops and hooks regions 110, 111 is responsible for fitting the suspension vest 102 around the abdomen or torso of a person. In some preferred embodiments, the suspension vest 102 houses material such as canvass or other flexible filling materials in order to impart more rigidity or firmness to the suspension vest 102.

The pressure created around the torso of the person which is applied by the suspension vest 102 provides the force through which a person is suspended over a chair or seat as it concerns the suspension vest 102. The tensile force created from the coupling of the mating chair appendage 101 and the suspension vest 102 also contributes to the suspension of a person, although this force is in relation to the chair or seat, wherein the chair or seat acts as the anchor or fulcrum. FIG. 1c also illustrates that on the outer surface of the suspension vest 102, the System and Apparatus for Suspending a Person 100 may further include a handle 135 in some preferred embodiments.

FIGS. 1a-1b illustrate that the mating chair appendage 101 is comprised of a plurality of straps 103, mating distal ends 104, 105, and a pad 185. FIGS. 11-12 illustrate that the straps 103 are comprised of a first distal end 226 and a second distal end 225. The straps 103 are affixed to the pad 185 at the first distal end 226 of the strap 103. The mating distal ends 104, 105, are affixed to the second distal end 225 of the strap 103. The pad 185 is comprised of an upper side 576 and a lower side 575 as illustrated in FIGS. 11-12. The upper side 576 is comprised of either loops or hooks material which mate with the suspension region of hooks or loops 905 of the suspension vest 102.

FIG. 5 illustrates that in some preferred embodiments the mating chair appendage 101 may further comprise a rigid planar member 150. Moreover, in this preferred embodiment, the mating chair appendage 101 will further comprise a pocket 151 for housing the mating chair appendage 101. In some preferred embodiments, this pocket may be comprised of nylon.

FIGS. 11-12 also illustrates that in some preferred embodiments, the mating distal ends 104, 105 are buckles. The buckles are comprised of a male end 501 and a female end 502. However, the System and Apparatus for Suspending a Person 100 a suspension vest 102 can also use other means of affixing the ends together. Therefore, the present invention should not be construed to only require one means of affixation over another.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A System and Apparatus for Suspending a Person comprising:
a suspension vest, and a mating chair appendage;
the suspension vest is coupled with the mating chair appendage;
the suspension vest is a flexible, elongate, and planar member;
the suspension vest is comprised of a set of fitting loops and hooks regions and a suspension region of hooks or loops;
the mating chair appendage is comprised of a plurality of straps, mating distal ends, and a pad;
the straps are comprised of a first distal end and a second distal end;
the straps are affixed to the pad at the first distal end of the strap;
the mating distal ends are affixed to the second distal end of the strap;
the pad is comprised of a an upper side and a lower side;
the upper side is comprised of either loops or hooks material and mate with the suspension region of hooks or loops of the suspension vest.

2. The System and Apparatus for Suspending a Person of claim 1 wherein the mating distal ends are buckles; the buckles are comprised of a male end and a female end.

3. The System and Apparatus for Suspending a Person of claim 1 wherein the straps are comprised of at least one set of longitudinal straps and at least two sets of circumferential straps.

4. The System and Apparatus for Suspending a Person of claim 1 wherein the lower side of the pad further comprises a series of studs.

5. The System and Apparatus for Suspending a Person of claim 1 further comprising a a rigid planar member; the a rigid planar member is housed within the mating chair appendage.
